(19) United States
(12) Patent Application Publication
(10) Pub. No.: US 2026/0075591 A1
(43) Pub. Date: Mar. 12, 2026

(54) CONCURRENCY HANDLING IN A WIRELESS COMMUNICATION SYSTEM

(71) Applicant: QUALCOMM Incorporated, San Diego, CA (US)

(72) Inventors: Aria Hasanzadezonuzy, Jersey City, NJ (US); Diana Maamari, San Diego, CA (US); Kianoush Hosseini, San Diego, CA (US); Gabi Sarkis, San Diego, CA (US); Jing Jiang, San Diego, CA (US)

(21) Appl. No.: 18/883,750

(22) Filed: Sep. 12, 2024

(51) Int. Cl. H04W 72/044; H04W 72/56

(52) U.S. Cl. CPC H04W 72/044; H04W 72/56

(57) ABSTRACT

In some aspects, an apparatus includes a processing system including one or more processors and one or more memories coupled to the one or more processors. The processing system is configured to receive scheduling information indicating a wireless communication operation scheduled for a slot. The scheduling information further indicates that the wireless communication operation is scheduled to use at least a first set of frequency resources. The slot is further associated with one or more measurement operations to be performed using at least a second set of frequency resources. The processing system is further configured to perform, during the slot, one or more of the wireless communication operation or the one or more measurement operations in accordance with a concurrency handling procedure.

### TECHNICAL FIELD

Aspects of the disclosure relate generally to wireless communication systems, and more particularly, to concurrently handling in a wireless communication system.

### DESCRIPTION OF THE RELATED TECHNOLOGY

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The systems, methods and devices of this disclosure each have several innovative aspects, no single one of which is solely responsible for the desirable attributes disclosed herein.

Some wireless communication systems may allocate resources into frequency resources, such as component carriers (CCs). The CCs may facilitate, for example, a wideband (WB) communication operation by a user equipment. To facilitate such operations, the UE may adjust one or more parameters, such as by increasing a baseband clock frequency or a control voltage. Such operating states may increase power consumption of the UE and may reduce performance as a result. Some other techniques may involve limiting the quantity of CCs used during operation, which may reduce performance (e.g., by reducing throughput).

In some aspects, one or more devices of a wireless communication system may operate in accordance with a concurrency handling procedure that specifies one or more concurrency handling operations to be performed if a concurrency condition is detected. In some examples, the concurrency condition may be associated with scheduling of a wireless communication operation and a measurement operation to be performed concurrently during a slot. In some examples, in response to detecting the concurrency condition, a UE may perform the one or more concurrency handling operations to reduce or avoid the need to adjust one or more parameters (such as a frequency of a clock signal of the UE) or to facilitate the adjustment of the one or more parameters.

To illustrate, in some examples, the concurrency handling procedure may be associated with a priority scheme specifying that one of the wireless communication operation or the one or more measurement operations has a greater priority than the other of the wireless communication operation or the one or more measurement operations. The one or more concurrency handling operations may include dropping, during the slot, the other of the wireless communication operation or the one or more measurement operations. In some other examples, the concurrency handling procedure may be associated with one or more of a switching gap interval or a processing time interval. In some such examples, the one or more concurrency handling operations may include one or more of increasing the frequency of the clock signal during the switching gap interval or performing processing associated with the one or more measurement operations during the processing time interval.

In some aspects, an apparatus for wireless communication by a user equipment (UE) includes a processing system including one or more processors and one or more memories coupled to the one or more processors. The processing system is configured to receive scheduling information indicating a wireless communication operation scheduled for a slot. The scheduling information further indicates that the wireless communication operation is scheduled to use at least a first set of frequency resources. The slot is further associated with one or more measurement operations to be performed by the UE using at least a second set of frequency resources. The processing system is further configured to perform, during the slot, one or more of the wireless communication operation or the one or more measurement operations in accordance with a concurrency handling procedure.

In some other aspects, a method of wireless communication performed by a user equipment (UE) includes receiving scheduling information indicating a wireless communication operation scheduled for a slot. The scheduling information further indicates that the wireless communication operation is scheduled to use at least a first set of frequency resources. The slot is further associated with one or more measurement operations to be performed by the UE using at least a second set of frequency resources. The method further includes performing, during the slot, one or more of the wireless communication operation or the one or more measurement operations in accordance with a concurrency handling procedure.

In some further aspects, an apparatus for wireless communication by a network node includes a processing system including one or more processors and one or more memories coupled to the one or more processors. The processing system is configured to transmit scheduling information indicating a wireless communication operation scheduled for a slot and to be performed by a user equipment (UE). The scheduling information further indicates that the wireless communication operation is scheduled to use at least a first set of frequency resources. The slot is further associated with one or more measurement operations to be performed by the UE using at least a second set of frequency resources. The processing system is further configured to perform one or more communications with the UE in accordance with the scheduling information and further in accordance with a concurrency handling procedure.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating an example wireless communication system that may operate in accordance with a concurrency handling procedure.

FIG. 2 is a block diagram illustrating examples of a base station and a user equipment (UE) that may operate in accordance with a concurrency handling procedure.

FIG. 3 is a block diagram illustrating an example wireless communication system that may operate in accordance with a concurrency handling procedure.

FIG. 4 is a diagram illustrating examples of priority schemes that may be associated with a concurrency handling procedure.

FIG. 5 is a diagram illustrating examples of switching gap intervals that may be associated with a concurrency handling procedure.

FIG. 6 is a diagram illustrating examples of processing time intervals that may be associated with a concurrency handling procedure.

FIG. 7 is a flow diagram illustrating an example process that supports concurrency handling.

FIG. 8 is a flow diagram illustrating another example process that supports concurrency handling.

FIG. 9 is a block diagram of an example UE that supports concurrency handling.

FIG. 10 is a block diagram of an example network node that supports concurrency handling.

Like reference numbers and designations in the various drawings indicate like elements.

### DETAILED DESCRIPTION

Some features of the disclosure may relate to wireless communication systems. To illustrate, one or more features described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), 6th Generation (6G) networks, as well as other communication networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, 5G NR, or 6G technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Wireless communication networks may include diverse deployments, diverse spectrum, and diverse services and devices that may be implemented using an OFDM-based unified, air interface. In some examples, a wireless communication network may be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In some wireless communication protocols, two initial operating bands may be identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

Some devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in a wireless communication system, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

A scalable numerology may facilitate scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. A wireless communication system may also be implemented using a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

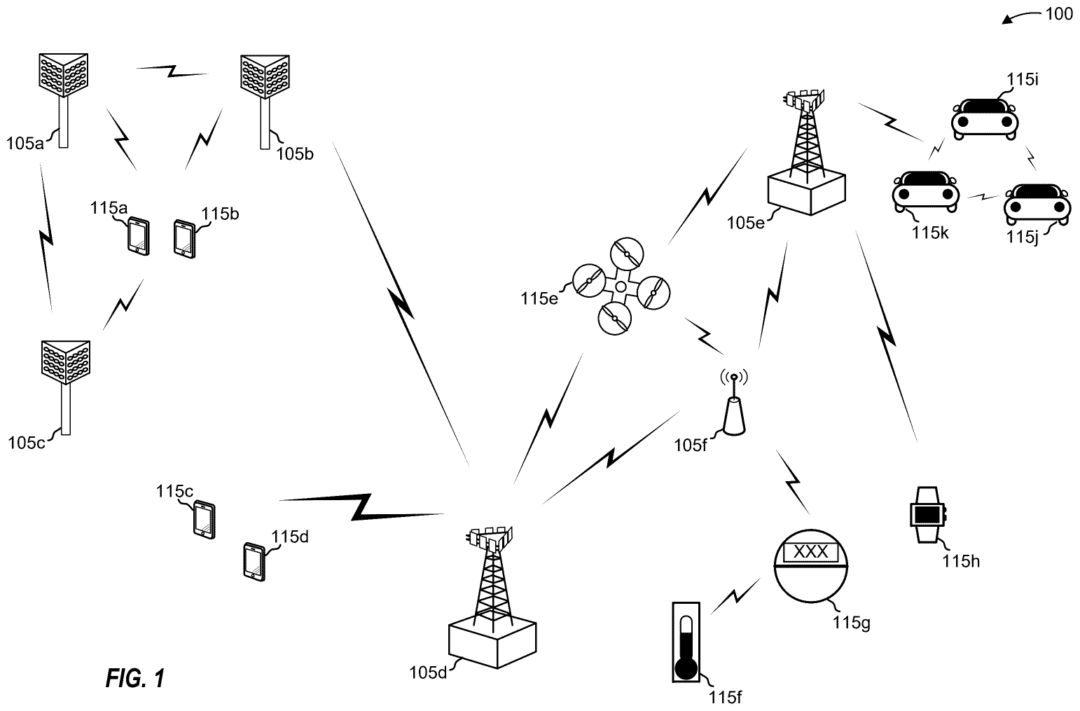

FIG. 1 is a block diagram illustrating an example wireless communication system that may operate in accordance with a concurrency handling procedure. The wireless communication system may include wireless network 100. Wireless network 100 may, for example, include a 5G wireless network, a 6G wireless network, or another wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

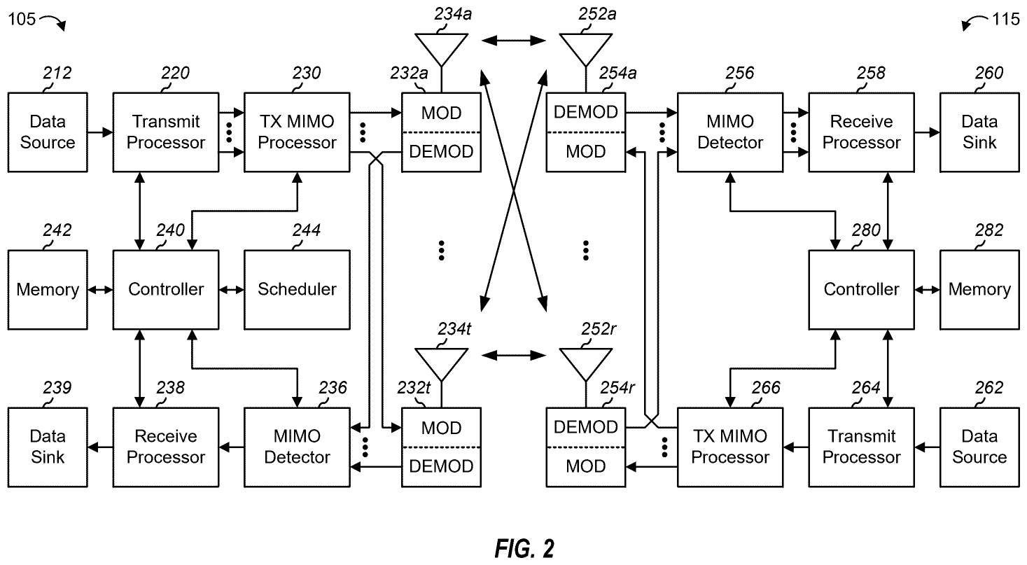

FIG. 2 is a block diagram illustrating examples of base station 105 and UE 115 that may operate in accordance with a concurrency handling procedure. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct one or more processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

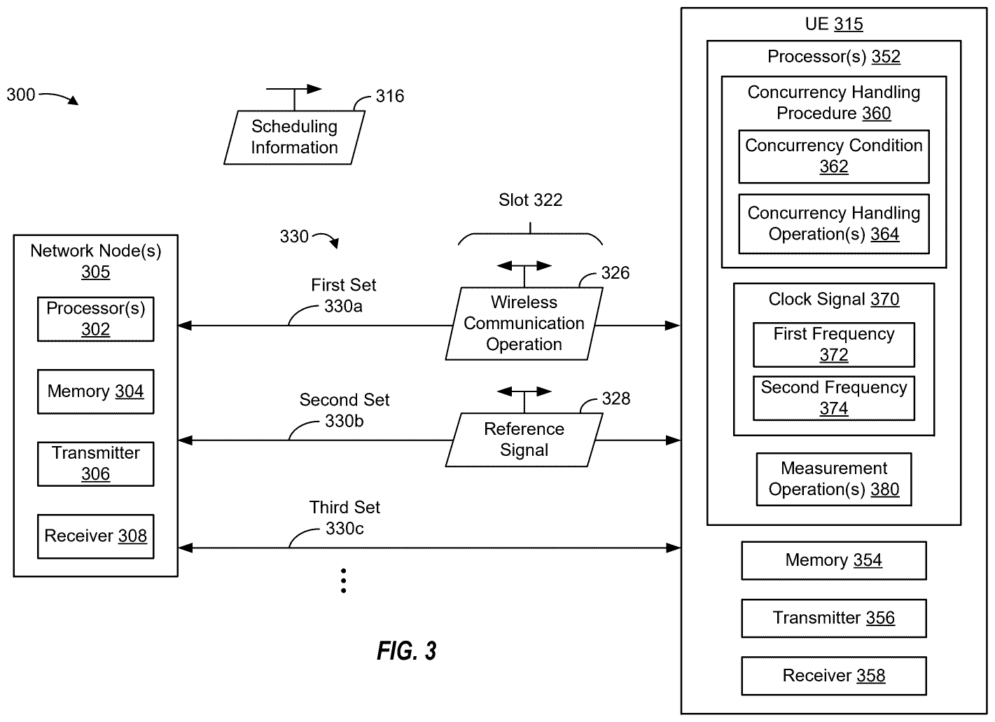

FIG. 3 is a block diagram illustrating an example wireless communication system 300 that may operate in accordance with a concurrency handling procedure 360. The wireless communication system 300 may include one or more UEs, such as a UE 315. In some examples, the UE 315 may correspond to the UE 115. The wireless communication system 300 may also include one or more network nodes 305. In some examples, the one or more network nodes 305 may include or may correspond to the base station 105. To further illustrate, the one or more network nodes 305 may include or may be implemented using one or more of a base station, a network controller, an integrated access and backhauling (IAB) node, a distributed unit (DU), a central unit (CU), or a remote/radio unit (RU) (which may also be referred to as a remote radio unit (RRU)), as illustrative examples.

In some implementations, the one or more network nodes 305 may support communication with the UE 315 using frequency resources 330. The frequency resources 330 may include, for example, a first set of frequency resources 330a and a second set of frequency resources 330b. The frequency resources 330 may optionally include one or more other sets of frequency resources, such as a third set of frequency resources 330c. In some examples, a set of frequency resources (such as the sets of frequency resources 330a, 330b, and 330c) may include or may be referred to as a component carrier (CC), a cell, or a sub-band. Further, in some examples, different sets of frequency resources may be associated with different respective network nodes. To illustrate, in some examples, the one or more network nodes 305 may include a first network node associated with the first set of frequency resources 330a and may further include a second network node associated with the second set of frequency resources 330b. In some other examples, the one or more network nodes 305 may include a single network node associated with the first set of frequency resources 330a and the second set of frequency resources 330b.

A network node of the one or more network nodes 305 may include a processing system including one or more processors 302 (such as the controller 240) and one or more memories (such as a memory 304, which may correspond to the memory 242). The network node may further include a transmitter 306 and a receiver 308. The one or more processors 302 may be coupled to the memory 304, to the transmitter 306, and to the receiver 308. In some examples, the transmitter 306 and the receiver 308 may include one or more components described with reference to FIG. 2, such as one or more of the modulator/demodulators 232a-t, the MIMO detector 236, the receive processor 238, the transmit processor 220, or the TX MIMO processor 230. In some examples, the one or more processors 302 may be configured to individually or collectively perform one or more operations described herein.

The transmitter 306 may transmit reference signals, synchronization signals, control information, and data to one or more other devices, and the receiver 308 may receive reference signals, control information, and data from one or more other devices. For example, in some implementations, the transmitter 306 may transmit signaling, control information, and data to the UE 315, and the receiver 308 may receive signaling, control information, and data from the UE 315.

The UE 315 may include a processing system including one or more processors 352 (such as the controller 280) and one or more memories (such as a memory 354, which may correspond to the memory 282). The UE 315 may further include a transmitter 356 and a receiver 358. The one or more processors 352 may be coupled to the memory 354, to the transmitter 356, and to the receiver 358. In some examples, the transmitter 356 and the receiver 358 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356 and the receiver 358 may be integrated in one or more transceivers of the UE 315. In some examples, the one or more processors 352 may be configured to individually or collectively perform one or more operations described herein.

The transmitter 356 may transmit reference signals, synchronization signals, control information, and data to one or more other devices, and the receiver 358 may receive reference signals, control information, and data from one or more other devices. For example, in some implementations, the transmitter 356 may transmit signaling, control information, and data to the one or more network nodes 305, and the receiver 358 may receive signaling, control information, and data from the one or more network nodes 305.

One or more components of the UE 315 may operate in accordance with a clock signal 370. For example, the one or more processors 352 may operate in accordance with the clock signal 370. In some examples, the clock signal 370 may correspond to, or may be referred to as, a baseband clock signal.

The wireless communication system 300 may use wireless communication channels, which may be specified by one or more wireless communication protocols, such as a 5G NR wireless communication protocol, a 6G wireless communication protocol, or another wireless communication protocol. To further illustrate, the one or more network nodes 305 may communicate with the UE 315 using one or more downlink wireless communication channels (such as via one or more of a PDSCH or a PDCCH). The UE 315 may communicate with the one or more network nodes 305 using one or more uplink wireless communication channels (such as via one or more of a PUSCH or a PUCCH). Alternatively, or in addition, the UE 315 may communicate with one or more other UEs, such as via a sidelink wireless communication channel.

During operation, the UE 315 may receive scheduling information 316, such as from a network node of the one or more network nodes 305. The scheduling information 316 may indicate that the UE 315 is scheduled to perform a wireless communication operation 326 during a slot 322. In some examples, the wireless communication operation 326 may include a downlink receive operation or an uplink transmit operation.

The scheduling information 316 may further indicate that the wireless communication operation 326 is scheduled to use at least one set of frequency resources of the frequency resources 330. For example, the scheduling information 316 may indicate that the wireless communication operation 326 is to use the first set of frequency resources 330a. In some examples, the first set of frequency resources 330a may be referred to as a scheduled set of frequency resources (or a scheduled CC), and the sets of frequency resources 330b, 330c may be referred to as non-scheduled sets of frequency resources (or non-scheduled CCs). In some examples, the scheduling information 316 may include or may correspond to downlink control information (DCI).

To further illustrate, in some implementations, the wireless communication system 300 may operate in accordance with a flexible spectrum infrastructure (FSI). The FSI may enable dynamic allocation and management of resources, such as the frequency resources 330. For example, the FSI may specify that at least some frequency resources of the frequency resources 330 may be dynamically activated or scheduled. Such dynamic activation of scheduling of the frequency resources 330 may also be referred to as efficient scheduling of the frequency resources 330.

In some circumstances, the UE 315 may be scheduled to perform one or more measurement operations 380 during the slot 322. For example, the one or more measurement operations 380 may include one or more of a periodically scheduled measurement, a semi-persistently scheduled (SPS) measurement, or a dynamically scheduled measurement. In some examples, performing the one or more measurement operations 380 may include receiving a reference signal 328. Further, the UE 315 may generate one or more measurement results in accordance with the reference signal 328 and may transmit a measurement report indicating at least one of the one or more measurement results. As referred to herein, a measurement operation may include or may refer to reception of the reference signal 328, transmission of the reference signal 328 or another reference signal (e.g., to enable the one or more network nodes 305 to receive and measure the reference signal), transmission of a measurement report, reception of a measurement report, transmission of HARQ feedback, or reception of HARQ feedback. To further illustrate, in some examples, the reference signal 328 may correspond a channel state information reference signal (CSI-RS), a tracking reference signal (TRS), a sounding reference signal (SRS), or another reference signal.

The UE 315 may detect that the wireless communication operation 326 and the one or more measurement operations 380 satisfy a concurrency condition 362 associated with the concurrency handling procedure 360. To illustrate, the concurrency handling procedure 360 may specify that the concurrency condition 362 is satisfied if a wireless communication operation and a measurement operation are scheduled for at least one common slot. In such examples, the UE 315 may detect that the wireless communication operation 326 and the one or more measurement operations 380 satisfy the concurrency condition 362 in accordance with the wireless communication operation 326 and the one or more measurement operations 380 being scheduled for the slot 322.

Alternatively, or in addition, the concurrency handling procedure 360 may specify that the concurrency condition 362 is satisfied if a wireless communication operation and a measurement operation are associated with an increase of a frequency of the clock signal 370 of the UE 315. To illustrate, in some examples, to concurrently perform the wireless communication operation 326 and the one or more measurement operations 380, the UE 315 may increase the clock signal 370 from a first frequency 372 to a second frequency 374. In such examples, the UE 315 may detect that the wireless communication operation 326 and the one or more measurement operations 380 satisfy the concurrency condition 362 in accordance with the wireless communication operation 326 and the one or more measurement operations 380 being associated with an increase of the frequency of the clock signal 370.

During the slot 322, the UE 315 may perform one or more of the wireless communication operation 326 or the one or more measurement operations 380. In some examples, the concurrency handling procedure 360 may specify which of the wireless communication operation 326 and the one or more measurement operations 380 is to be performed by the UE 315. Some such examples are described further below.

In addition, in accordance with the wireless communication operation and the one or more measurement operations satisfying the concurrency condition 362, the UE 315 may perform one or more concurrency handling operations 364 of the concurrency handling procedure 360. Some examples of the one or more concurrency handling operations 364 are described further below.

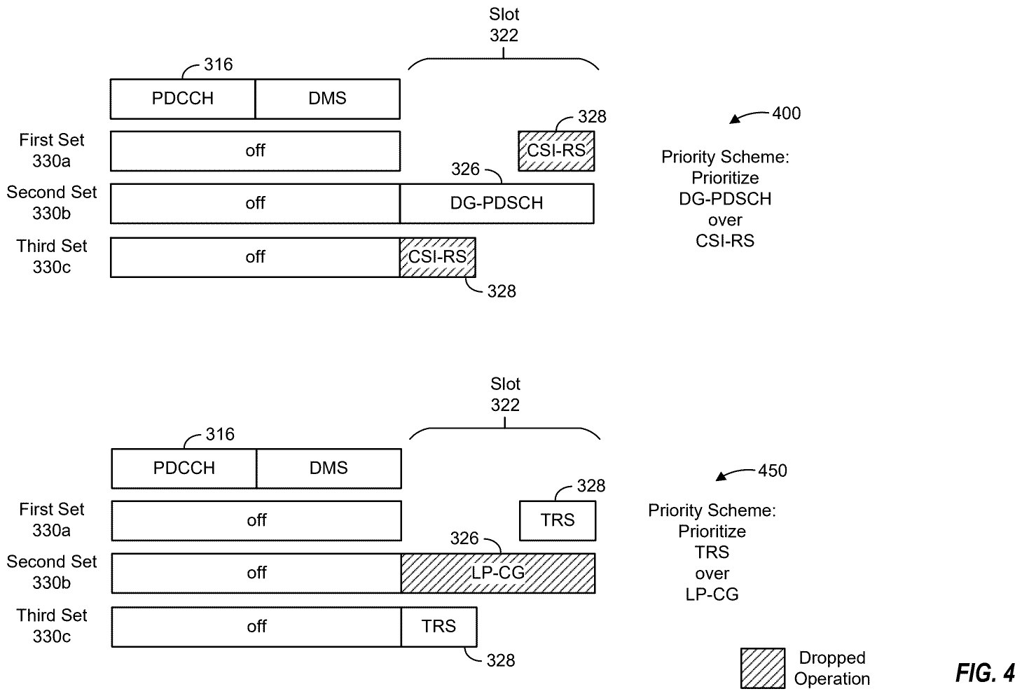

FIG. 4 is a diagram illustrating examples of priority schemes 400, 450 that may be associated with the concurrency handling procedure 360 of FIG. 3. In the example of FIG. 4, the scheduling information 316 may be received via a PDCCH. Further, in some implementations, a deep micro sleep (DMS) operation may be performed in connection with reception of the scheduling information 316. For example, the DMS operation may include entering a DMS state for a particular set of frequency resources during a portion of a slot after receiving the scheduling information 316 using the particular set of frequency resources during another portion of the slot. In some examples, other sets of frequency resources may be unused or inactive (e.g., “off”) during the DMS operation. Further, FIG. 4 also illustrates that the wireless communication operation 326 may include a dynamic grant PDSCH (DG-PDSCH) or a low-priority configured grant (LP-CG) and that the reference signal 328 may include a channel state information reference signal (CSI-RS) or a tracking reference signal (TRS). Other examples are also within the scope of the disclosure.

A priority scheme associated with the concurrency handling procedure 360 may specify that an operation of a first type is of a greater priority than an operation of a second type. In such examples, the UE 315 may drop, in connection with the concurrency handling procedure 360, an operation of the second type during the slot 322 to facilitate performance of an operation of the first type during the slot 322. Accordingly, a priority scheme associated with the concurrency handling procedure 360 may specify that one of the wireless communication operation 326 or the one or more measurement operations 380 has a greater priority than the other of the wireless communication operation 326 or the one or more measurement operations 380, and the one or more concurrency handling operations 364 of FIG. 3 may include dropping, during the slot 322, the other of the wireless communication operation 326 or the one or more measurement operations 380.

To illustrate, in some examples, the concurrency handling procedure 360 may be associated with the priority scheme 400. The priority scheme 400 may specify, for example, that a downlink receive operation, an uplink transmit operation, a PDSCH receive operation, a PUSCH transmit operation, or a DG-PDSCH receive operation is of a greater priority than a reference signal receive operation or a CSI-RS receive operation. In some such examples, during the slot 322, the UE 315 may drop the one or more measurement operations 380 (which may include CSI-RS measurement operations in the example of the priority scheme 400) and may perform the wireless communication operation 326 (which may include a DG-PDSCH operation in the example of the priority scheme 400).

Alternatively, or in addition, the concurrency handling procedure 360 may be associated with the priority scheme 450. The priority scheme 450 may specify, for example, that a reference signal receive operation or a TRS receive operation is of a greater priority than a transmit operation, a CG transmit operation, or an LP-CG transmit operation. In some such examples, during the slot 322, the UE 315 may drop the wireless communication operation 326 (which may include an LP-CG transmit operation in the example of the priority scheme 450) and may perform the one or more measurement operations (which may include a TRS receive operation in the example of the priority scheme 450).

In some examples, a priority scheme may be configured by a network node (e.g., by the one or more network nodes 305) or may be specified by a wireless communication protocol. To illustrate, in some examples, the one or more network nodes 305 may configure the UE 315 with one or more of the priority schemes 400, 450, such as via one or more radio resource control (RRC) configuration messages. Further, a priority scheme may be semi-static and may be dynamically changed or configured.

It is noted that the examples depicted in FIG. 4 are illustrative and that other examples are also within the scope of the disclosure. For example, a priority scheme may specify that DCI-scheduled wireless communication operations (such as a PDSCH receive operation or a PUSCH transmit operation) may have a greater priority than activity on non-scheduled sets of frequency resources. Alternatively, or in addition, a priority scheme may specify whether semi-persistently scheduled (SPS) have a greater priority than downlink or uplink measurements on non-scheduled sets of frequency resources. Alternatively, or in addition, a priority scheme may specify that a network-indicated logical channel (LCH) has a greater priority than downlink or uplink measurements on non-scheduled sets of frequency resources. Alternatively, or in addition, a priority scheme may specify that any of a PUCCH transmission, a prioritized LCH, HARQ feedback, or aperiodic SCI have a greater priority than downlink or uplink measurements on non-scheduled sets of frequency resources.

Some examples described with reference to FIG. 4 may prioritize among dynamically scheduled operations (e.g., a PDSCH receive operation or a PUSCH transmit operation) and other operations (e.g., a periodically scheduled operation or an SPS operation). Other examples are also within the scope of the disclosure. For example, a priority scheme may specify prioritization among multiple dynamically scheduled operations, which may be beneficial, for example, if scheduling by the one or more network nodes 305 is not fully aligned or in the case of a modular CA scheduler, as illustrative examples.

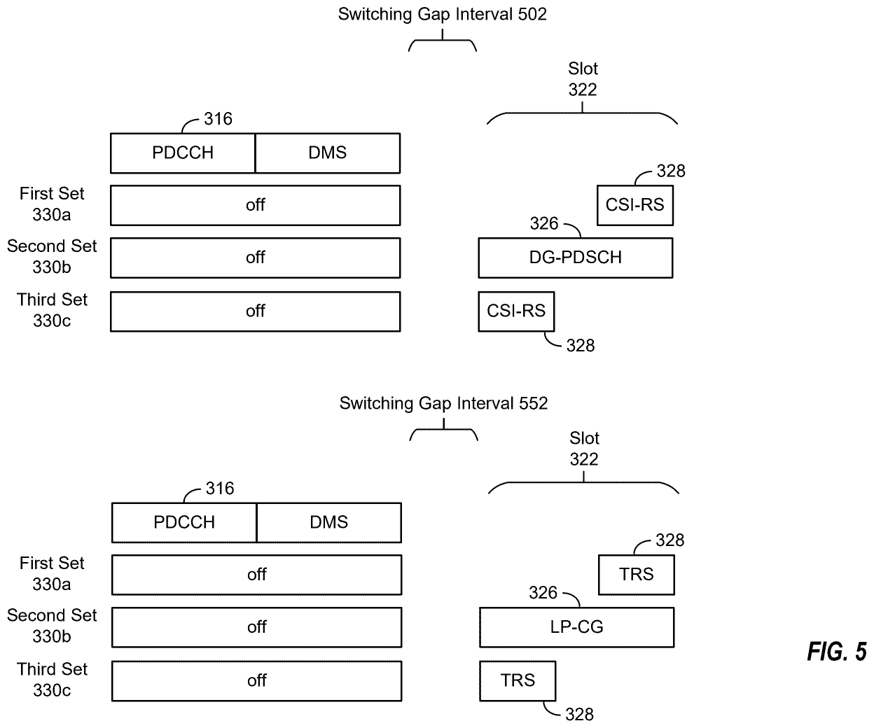

FIG. 5 is a diagram illustrating examples of switching gap intervals 502, 552 that may be associated with the concurrency handling procedure 360 of FIG. 3. In the example of the switching gap interval 502, the UE 315 may adjust a frequency of the clock signal 370 (e.g., from the first frequency 372 to the second frequency 374) during the switching gap interval 502. After adjusting the frequency of the clock signal 370, the UE 315 may perform both the wireless communication operation 326 (e.g., a DG-PDSCH) and the one or more measurement operations 380 (e.g., by receiving one or more CSI-RSs) using the adjusted frequency (e.g., the second frequency 374) of the clock signal 370.

In the example of the switching gap interval 552, the UE 315 may adjust the frequency of the clock signal 370 (e.g., from the first frequency 372 to the second frequency 374) during the switching gap interval 552. After adjusting the frequency of the clock signal 370, the UE 315 may perform both the wireless communication operation 326 (e.g., an LP-CG) and the one or more measurement operations 380 (e.g., by receiving one or more TRSs) using the adjusted frequency (e.g., the second frequency 374) of the clock signal 370.

In some implementations, the switching gap intervals 502, 552 may correspond to a time duration allocated for the UE 315 to be ready to receive a downlink data signal (such as a PDSCH signal) after decoding of a downlink control signal (such as a PDCCH signal) scheduling the downlink data signal. In such examples, the switching gap intervals 502, 552 may be referred to as an N1 time duration.

Accordingly, the example of FIG. 5 illustrates that the concurrency handling procedure 360 may be associated with a switching gap interval, such as one or more of the switching gap intervals 502, 552. Further, performing the one or more concurrency handling operations 364 may include increasing a frequency of the clock signal 370 from the first frequency 372 to the second frequency 374 and performing the one or more measurement operations 380 using the second frequency 374 of the clock signal 370.

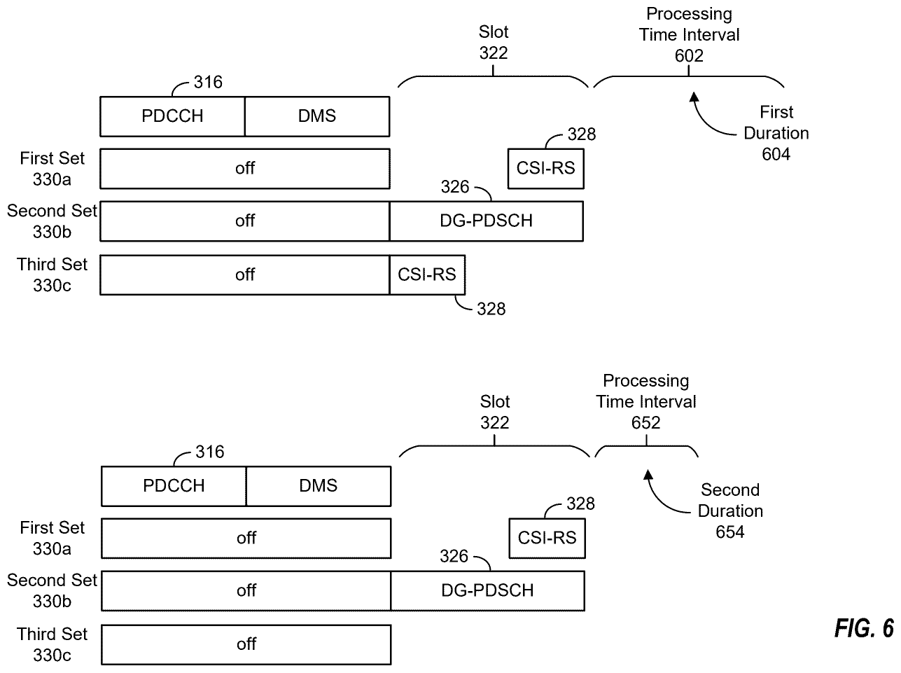

FIG. 6 is a diagram illustrating examples of processing time intervals 602, 652 that may be associated with the concurrency handling procedure 360 of FIG. 3. To illustrate, the processing time interval 602 may follow the slot 322, and the one or more concurrency handling operations 364 may include performing processing associated with the one or more measurement operations 380 during the processing time interval 602. In an example, the processing associated with the one or more measurement operations 380 may include generating a CSI report (or determining one or more values of the CSI report) in accordance with measurement of the reference signal 328 of FIG. 3 during the slot 322. In another examples, the processing may include generating or transmitting HARQ feedback associated with a reception operation (such as a PDSCH reception operation).

To further illustrate, the processing time interval 652 may follow the slot 322, and the one or more concurrency handling operations 364 may include performing processing associated with the one or more measurement operations 380 during the processing time interval 652. In an example, the processing associated with the one or more measurement operations 380 may include generating a CSI report (or determining one or more values of the CSI report) in accordance with measurement of the reference signal 328 of FIG. 3 during the slot 322.

In some implementations, the processing time intervals 602, 652 may correspond to a quantity of time slots allocated for the UE 315 to initiate transmission of HARQ feedback associated with a downlink data signal (such as a PDSCH signal) after receiving the downlink data signal. In such examples, the processing time intervals 602, 652 may be referred to as a k1 quantity of time slots.

In some implementations, the concurrency handling procedure 360 may specify that a duration of a processing time interval is in accordance with a quantity q of frequency resources associated with the one or more measurement operations 380. For example, the concurrency handling procedure 360 may specify that a greater quantity q of CCs may be associated with a greater duration of a processing time interval (e.g., to allocate more processing time for a greater quantity of measurements associated with the greater quantity of CCs). To further illustrate, in an example of the processing time interval 602, the one or more measurement operations 380 may use two CCs, and in an example of the processing time interval 652, the one or more measurement operations 380 may use one CC. In some examples, each such CC may be associated with a particular amount of time (such as an amount x of microseconds), and the particular duration of a processing time interval may correspond to (or may be based on) the product of the quantity of CCs and the particular amount of time. In such examples, the duration of a processing time interval may correspond to (or may be based on) qx. Accordingly, the processing time interval 602 may be associated with a first duration 604 that is greater than a second duration 654 associated with the processing time interval 652. Other examples are also within the scope of the disclosure. For example, in some implementations, a duration of a processing time interval may be based on a quantity of measurement processes to be performed or a quantity or type of parameters to report in a CSI measurement report, such as a layer one (L1) reference signal received power (RSRP), a precoding matrix indicator (PMI), a rank indicator (RI), and a channel quantity indicator (CQI). In some additional examples, the processing time intervals 602, 652 may be associated with a common duration. Similarly, in some examples, the switching gap intervals 502, 552 of FIG. 5 may have a common duration or may have different durations, such as durations that are based on qx or another metric.

Accordingly, FIG. 4 illustrates examples of priority schemes 400, 450, FIG. 5 illustrates examples of switching gap intervals 502, 552, and FIG. 6 illustrates examples of processing time intervals 602, 652. The concurrency handling procedure 360 of FIG. 3 may be associated with any of the priority schemes 400, 450, the switching gap intervals 502, 552, and the processing time intervals 602, 652. Alternatively, or in addition, other examples are also within the scope of the disclosure, such as one or more of the following examples.

In an example, the concurrency handling procedure 360 may specify that no measurements are to be performed concurrently with wireless communications (such as the wireless communication operation 326) or that no aperiodic measurements are to be triggered on non-scheduled sets of frequency resources during the slot 322 (or proximate to the slot 322). In some such examples, the UE 315 may “expect” not to be scheduled to perform the wireless communication operation 326 concurrently with the one or more measurement operations 380. Further, in some such examples, if the UE 315 identifies that the wireless communication operation 326 concurrently with the one or more measurement operations 380, the one or more concurrency handling operations 364 may include avoiding performance of the one or more measurement operations 380 in accordance with detection of the concurrency condition 362 (e.g., by dropping the one or more measurement operations 380). In some examples, the UE 315 may ignore the one or more measurement operations 380 if the one or more measurement operations 380 are of a particular type (such as an SPS type or a periodic type).

In some other examples, if the UE 315 identifies that the wireless communication operation 326 concurrently with the one or more measurement operations 380, the one or more concurrency handling operations 364 may include performing the one or more measurement operations 380 using a reference signal that is configured to avoid overlap with the wireless communication operation 326. For example, if the UE 315 identifies that the wireless communication operation 326 concurrently with the one or more measurement operations 380, the UE 315 may “expect” that the reference signal 328 includes resources that are non-overlapping with resources of the wireless communication operation 326. In some implementations, efficient scheduling of the frequency resources 330 may also trigger configuration of the reference signal 328 to include resources that are non-overlapping with resources of the wireless communication operation 326. The resources may also be referred to a resource pattern.

In another example, the UE 315 may receive an indication that the UE 315 is enabled to reduce or maintain a frequency of the clock signal 370 (e.g., by setting the clock signal 370 to the first frequency 372 instead of the second frequency 374), and the UE 315 may “ignore” the indication (e.g., by setting the clock signal 370 to the second frequency 374). To illustrate, the scheduling information 316 (or another indication) may indicate a quantity of frequency resources associated with the slot 322. The quantity may enable the UE 315 to reduce the clock signal of the UE to the first frequency 372 from the second frequency 374. In some examples, the UE 315 may identify one or more clock frequency increase criteria and may set the clock signal 370 to the second frequency 374 irrespective of the indication. For example, the one or more clock frequency increase criteria may include a determination that the UE 315 is to perform a non-network related operation using another set of frequency resources, cell CC, or sub-band or that one or more processes of the UE 315 are associated with the second frequency 374. Further, in some examples, the one or more concurrency handling operations 364 may include transmitting a message (e.g., to a network node of the one or more network nodes 305) indicating that the UE 315 to maintain use of the second frequency 374 during the slot 322. In some examples, the UE 315 may transmit the message in accordance with detecting that the one or more processes of the UE are associated with the second frequency 374. In some examples, the message may cause the one or more network nodes 305 to avoid one or more concurrency handling operations. For example, the message may cause the one or more network nodes 305 to avoid considering a switching gap interval or a processing time interval in connection with scheduling.

Further, although some techniques have been described separately for convenience, in some implementations, the concurrency handling procedure 360 may be associated with multiple different techniques described herein. As an illustrative example, different types of concurrency may be associated with different concurrency handling operations 364. As another illustrative example, the concurrency handling procedure 360 may specify that the UE 315 is to follow a priority scheme (such as one or more of the priority scheme 400 or the priority scheme 450) as a primary technique. The concurrency handling procedure 360 may also specify a secondary technique (e.g., “tiebreaker” in the event of a “tie”), such as in case the priority scheme assigns equal priorities to the wireless communication operation 326 and the one or more measurement operations 380. The secondary technique may include, for example, use of a switching gap interval (e.g., one or more of the switching gap interval 502 or the switching gap interval 552) or a processing time interval (e.g., one or more of the processing time interval 602 or the processing time interval 652), as illustrative examples. Other examples are also within the scope of the disclosure.

In some examples, one or more features associated with the concurrency handling procedure 360 may be configured by the one or more network nodes 305. For example, the one or more network nodes 305 may configure the UE 315 with one or more features of the concurrency handling procedure 360 via a radio resource control (RRC) configuration message or via other signaling. Such configuration may be performed (or changed) dynamically in some implementations. Alternatively, or in addition, a wireless communication protocol may specify one or more features of the concurrency handling procedure 360. Further, in some implementations, one or more features of the concurrency handling procedure 360 may be selectively activated, deactivated, or both, such as via downlink control information (DCI) or via one or more medium access control (MAC) control element (MAC-CEs) transmitted by the one or more network nodes 305 to the UE 315. In addition, in some examples, the UE 315 may report a capability for supporting one or more features associated with the concurrency handling procedure 360. For example, the UE 315 may report a capability for supporting one or more of a priority scheme (such as one or more of the priority scheme 400 or the priority scheme 450), a switching gap interval (e.g., one or more of the switching gap interval 502 or the switching gap interval 552), a processing time interval (e.g., one or more of the processing time interval 602 or the processing time interval 652), or another technique described herein, as illustrative examples.

Although some examples may be described with reference to the clock signal 370, other examples are also within the scope of the disclosure. For example, alternatively or in addition to adjusting a frequency of the clock signal 370, the UE 315 may adjust one or more other parameters (e.g., in accordance with a quantity of CCs to be used during the slot 322). In some examples, the one or more other parameters may include a control voltage provided to one or more components of the UE 315.

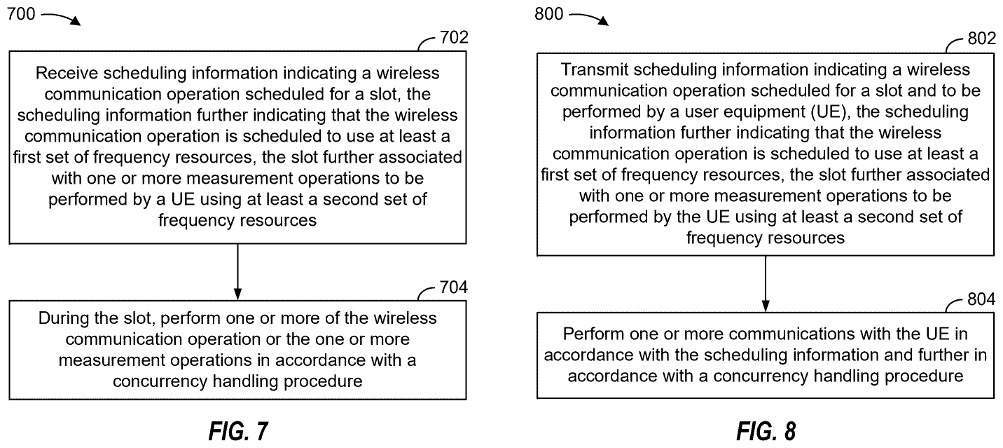

FIG. 7 is a flow diagram illustrating an example method 700 according to one or more aspects. In some examples, the method 700 may be performed by a UE, such as the UE 115 or the UE 315.

The method 700 includes receiving scheduling information indicating a wireless communication operation scheduled for a slot, at 702. The scheduling information further indicates that the wireless communication operation is scheduled to use at least a first set of frequency resources, and the slot is further associated with one or more measurement operations to be performed by the UE using at least a second set of frequency resources. For example, the UE 315 may receive the scheduling information 316 indicating the wireless communication operation 326 scheduled for the slot 322. The scheduling information 316 may further indicate that the wireless communication operation 326 is scheduled to use at least the first set of frequency resources 330a. The slot 322 may be further associated with the one or more measurement operations 380 to be performed by the UE 315 using at least the second set of frequency resources 330b.

The method 700 further includes performing, during the slot, one or more of the wireless communication operation or the one or more measurement operations in accordance with a concurrency handing procedure, at 704. For example, the UE 315 may selectively perform the wireless communication operation 326, the one or more measurement operations 380, or the both, using one or more techniques described herein, such as using one or more techniques described with reference to the concurrency handling procedure 360. In some examples, the UE 315 may perform the one or more concurrency handling operations 364 of the concurrency handling procedure 360 in accordance with the wireless communication operation 326 and the one or more measurement operations 380 satisfying the concurrency condition 362.

FIG. 8 is a flow diagram illustrating an example method 800 according to one or more aspects. In some examples, the method 800 may be performed by a network node (e.g., a base station). For example, the method 800 may be performed by the base station 105 or by a network node of the one or more network nodes 305.

The method 800 includes transmitting scheduling information indicating a wireless communication operation scheduled for a slot and to be performed by a user equipment (UE), at 802. The scheduling information further indicates that the wireless communication operation is scheduled to use at least a first set of frequency resources, and the slot is further associated with one or more measurement operations to be performed by the UE using at least a second set of frequency resources. For example, a network node of the one or more network nodes 305 may transmit the scheduling information 316 indicating the wireless communication operation 326 scheduled for the slot 322. The scheduling information 316 may further indicate that the wireless communication operation 326 is scheduled to use at least the first set of frequency resources 330a. The slot 322 may be further associated with the one or more measurement operations 380 to be performed by the UE 315 using at least the second set of frequency resources 330b.

The method 800 further includes performing one or more communications with the UE in accordance with the scheduling information and further in accordance with a concurrency handling procedure, at 804. To illustrate, in some examples, the concurrency handling procedure 360 may be associated with a priority scheme (such as the priority scheme 400, the priority scheme 450, or both), and the one or more communications may be performed in accordance with the priority scheme. In some other examples, the concurrency handling procedure 360 may be associated with a switching gap interval (such as the switching gap interval 502 or the switching gap interval 552), and the one or more communications may be performed in accordance with the switching gap interval. In some further examples, the concurrency handling procedure 360 may be associated with a processing time interval (such as the processing time interval 602 or the processing time interval 652) following the slot, and the one or more communications may be performed in accordance with the processing time interval. Further, in some examples, the concurrency handling procedure 360 may specify that a duration of the processing time interval is in accordance with a quantity of frequency resources included in the second set of frequency resources.

In some examples, performing the one or more communication operations may include performing the wireless communication operation 326. Alternatively, or in addition, performing the one or more communication operations may include one or more other operations, such as receiving a measurement report from the UE 315 in accordance with the one or more measurement operations 380, as an illustrative example.

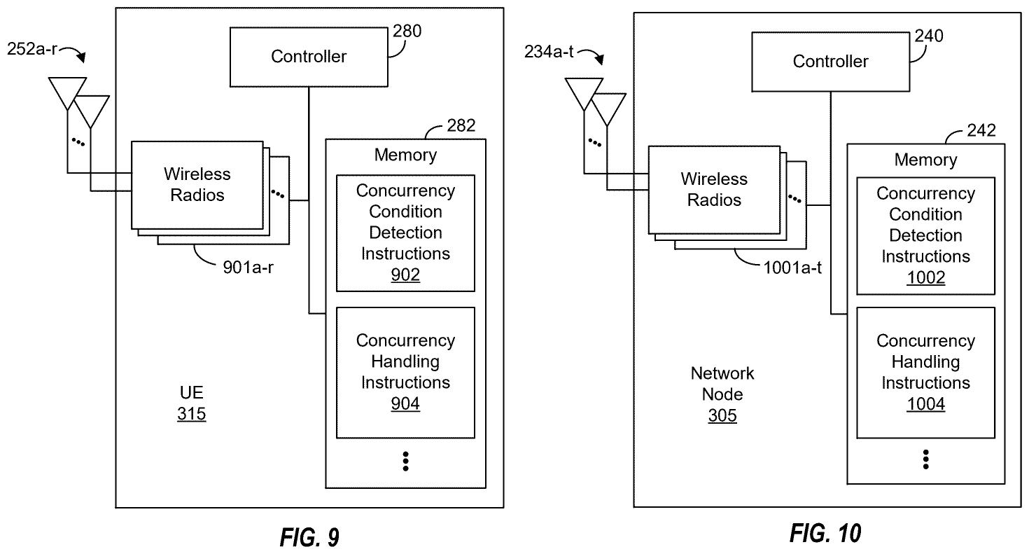

FIG. 9 is a block diagram of an example UE 315 according to one or more aspects. The UE 315 may include structure, hardware, or components illustrated in FIG. 2. For example, the UE 315 may include the controller 280, which may execute instructions stored in the memory 282. Using the controller 280, the UE 115 may transmit and receive signals via wireless radios 901a-r and antennas 252a-r. The wireless radios 901a-r may include one or more components or devices described herein, such as the modulator/demodulators 254a-r, the MIMO detector 256, the receive processor 258, the transmit processor 264, the TX MIMO processor 266, the transmitter 356, the receiver 358, one or more other components or devices, or a combination thereof.

In some examples, the memory 282 may store instructions executable by one or more processors (e.g., the controller 280) to initiate, perform, or control one or more operations described herein. For example, the memory 282 may store concurrency condition detection instructions 902 executable by the controller 280 to detect that the concurrency condition 362 is satisfied. As another example, the memory 282 may store concurrency handling instructions 904 executable by the controller 280 to initiate, perform, or control the one or more concurrency handling operations 364.

FIG. 10 is a block diagram of an example network node 305 according to one or more aspects. The network node 305 may include structure, hardware, and components illustrated in FIG. 2. For example, the network node 305 may include the controller 240, which may execute instructions stored in memory 242. Under control of the controller 240, the network node 305 may transmit and receive signals via wireless radios 1001a-t and antennas 234a-t. The wireless radios 1001a-t may include one or more components or devices described herein, such as the modulator/demodulators 232a-t, the MIMO detector 236, the receive processor 238, the transmit processor 220, the TX MIMO processor 230, the transmitter 306, the receiver 308, one or more other components or devices, or a combination thereof.

In some examples, the memory 242 may store instructions executable by one or more processors (e.g., the controller 240) to initiate, perform, or control one or more operations described herein. For example, the memory 242 may store concurrency condition detection instructions 1002 executable by the controller 240 to detect that the concurrency condition 362 is satisfied. As another example, the memory 242 may store concurrency handling instructions 1004 executable by the controller 240 to perform, in accordance the concurrency condition 362 being satisfied, one or more communications with the UE 315 in accordance with the concurrency handling procedure 360.

One or more features described herein may improve performance of one or more devices within a wireless communication system, such as the wireless communication system 300. For example, use of the concurrency handling procedure 360 may reduce the need of the UE 315 to adjust one or more parameters (e.g., by reducing or avoiding the need to reduce the frequency of the clock signal 370) or may facilitate the adjustment (e.g., by enabling the UE 315 to reduce the frequency of the clock signal 370 during a switching gap interval or to perform processing during a processing time interval). As a result, the UE may use the frequency resources 330 while also reducing power consumption, mitigating conflict between the wireless communication operation 326 and the one or more measurement operations 380, or both.

In a first aspect, an apparatus for wireless communication by a user equipment (UE) includes a processing system including one or more processors and one or more memories coupled to the one or more processors. The processing system is configured to receive scheduling information indicating a wireless communication operation scheduled for a slot. The scheduling information further indicates that the wireless communication operation is scheduled to use at least a first set of frequency resources. The slot is further associated with one or more measurement operations to be performed by the UE using at least a second set of frequency resources. The processing system is further configured to perform, during the slot, one or more of the wireless communication operation or the one or more measurement operations in accordance with a concurrency handling procedure.

In a second aspect, in combination with the first aspect, the concurrency handling procedure is associated with a priority scheme specifying that one of the wireless communication operation or the one or more measurement operations has a greater priority than the other of the wireless communication operation or the one or more measurement operations, and the processing system is further configured to drop, during the slot, the other of the wireless communication operation or the one or more measurement operations.

In a third aspect, in combination with one or more of the first aspect or the second aspect, the concurrency handling procedure is associated with a switching gap interval, and the processing system is further configured to: during the switching gap interval, increase a frequency of a clock signal of the UE from a first frequency to a second frequency that is greater than the first frequency; and perform the one or more measurement operations using the second frequency of the clock signal.

In a fourth aspect, in combination with one or more of the first aspect through the third aspect, the concurrency handling procedure is associated with a processing time interval following the slot, and the processing system is further configured to perform processing associated with the one or more measurement operations during the processing time interval.

In a fifth aspect, in combination with one or more of the first aspect through the fourth aspect, the concurrency handling procedure specifies that a duration of the processing time interval is in accordance with a quantity of frequency resources included in the second set of frequency resources.

In a sixth aspect, in combination with one or more of the first aspect through the fifth aspect, the concurrency handling procedure specifies that no measurements are to be performed concurrently with the wireless communication operation.

In a seventh aspect, in combination with one or more of the first aspect through the sixth aspect, the processing system is further configured to perform one of: avoid performance of the one or more measurement operations in accordance with the concurrency handling procedure; or perform in accordance with the concurrency handling procedure, the one or more measurement operations using a reference signal that is configured to avoid overlap with the wireless communication operation.

In an eighth aspect, in combination with one or more of the first aspect through the seventh aspect, the scheduling information further indicates that a quantity of frequency resources associated with the slot enables the UE to reduce a clock signal of the UE to a first frequency from a second frequency that is greater than the first frequency, and the processing system is further configured to transmit a message indicating that the UE is to maintain use of the second frequency during the slot.

In a ninth aspect, in combination with one or more of the first aspect through the eighth aspect, the processing system is further configured to transmit, in accordance with detecting that one or more processes of the UE are associated with the second frequency, a message indicating that the UE is to maintain use of the second frequency during the slot.

In a tenth aspect, in combination with one or more of the first aspect through the ninth aspect, the processing system is further configured to detect a concurrency condition associated with the concurrency handling procedure in accordance with: the one or more measurement operations and the wireless communication operation being concurrently scheduled for the slot; or the one or more measurement operations and the wireless communication operation being associated with an increase of a frequency of a clock signal of the UE.

In an eleventh aspect, a method of wireless communication performed by a user equipment (UE) includes receiving scheduling information indicating a wireless communication operation scheduled for a slot. The scheduling information further indicates that the wireless communication operation is scheduled to use at least a first set of frequency resources. The slot is further associated with one or more measurement operations to be performed by the UE using at least a second set of frequency resources. The method further includes performing, during the slot, one or more of the wireless communication operation or the one or more measurement operations in accordance with a concurrency handling procedure.

In a twelfth aspect, in combination with the eleventh aspect, the concurrency handling procedure is associated with a priority scheme specifying that one of the wireless communication operation or the one or more measurement operations has a greater priority than the other of the wireless communication operation or the one or more measurement operations, and the method further includes dropping, during the slot, the other of the wireless communication operation or the one or more measurement operations.

In a thirteenth aspect, in combination with one or more of the eleventh aspect through the twelfth aspect, the concurrency handling procedure is associated with a switching gap interval, and the method further includes: during the switching gap interval, increasing a frequency of a clock signal of the UE from a first frequency to a second frequency that is greater than the first frequency; and performing the one or more measurement operations using the second frequency of the clock signal.

In a fourteenth aspect, in combination with one or more of the eleventh aspect through the thirteenth aspect, the concurrency handling procedure is associated with a processing time interval following the slot, and the method further includes performing processing associated with the one or more measurement operations during the processing time interval.

In a fifteenth aspect, in combination with one or more of the eleventh aspect through the fourteenth aspect, the concurrency handling procedure specifies that a duration of the processing time interval is in accordance with a quantity of frequency resources included in the second set of frequency resources.

In a sixteenth aspect, in combination with one or more of the eleventh aspect through the fifteenth aspect, the concurrency handling procedure specifies that no measurements are to be performed concurrently with the wireless communication operation.

In a seventeenth aspect, in combination with one or more of the eleventh aspect through the sixteenth aspect, the method further includes one of: avoiding performance of the one or more measurement operations in accordance with detection of a concurrency condition associated with the concurrency handling procedure; or performing, in accordance with the concurrency handling procedure, the one or more measurement operations using a reference signal that is configured to avoid overlap with the wireless communication operation.

In an eighteenth aspect, in combination with one or more of the eleventh aspect through the seventeenth aspect, the scheduling information further indicates that a quantity of frequency resources associated with the slot enables the UE to reduce a clock signal of the UE to a first frequency from a second frequency that is greater than the first frequency, and the method further includes transmitting a message indicating that the UE is to maintain use of the second frequency during the slot.

In a nineteenth aspect, in combination with one or more of the eleventh aspect through the eighteenth aspect, the UE transmits the message in accordance with detecting that one or more processes of the UE are associated with the second frequency.

In a twentieth aspect, an apparatus for wireless communication by a network node includes a processing system including one or more processors and one or more memories coupled to the one or more processors. The processing system is configured to transmit scheduling information indicating a wireless communication operation scheduled for a slot and to be performed by a user equipment (UE). The scheduling information further indicates that the wireless communication operation is scheduled to use at least a first set of frequency resources. The slot is further associated with one or more measurement operations to be performed by the UE using at least a second set of frequency resources. The processing system is further configured to perform one or more communications with the UE in accordance with the scheduling information and further in accordance with a concurrency handling procedure.

In the figures, a single block may be described as performing a function or functions. The function or functions performed by that block may be performed in a single component or across multiple components. Further, the function or functions may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean one or more of instructions, instruction sets, code, code segments, program code, programs, subprograms, software modules, application, software applications, software packages, routines, subroutines, objects, executables, threads of execution, procedures, or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), the apparatus comprising:
a processing system comprising one or more processors and one or more memories coupled to the one or more processors, the processing system configured to:
receive scheduling information indicating a wireless communication operation scheduled for a slot, the scheduling information further indicating that the wireless communication operation is scheduled to use at least a first set of frequency resources, the slot further associated with one or more measurement operations to be performed by the UE using at least a second set of frequency resources; and
during the slot, perform one or more of the wireless communication operation or the one or more measurement operations in accordance with a concurrency handling procedure.

2. The apparatus of claim 1, wherein the concurrency handling procedure is associated with a priority scheme specifying that one of the wireless communication operation or the one or more measurement operations has a greater priority than the other of the wireless communication operation or the one or more measurement operations, and wherein the processing system is further configured to drop, during the slot, the other of the wireless communication operation or the one or more measurement operations.

3. The apparatus of claim 1, wherein the concurrency handling procedure is associated with a switching gap interval, and wherein the processing system is further configured to:
during the switching gap interval, increase a frequency of a clock signal of the UE from a first frequency to a second frequency that is greater than the first frequency; and
perform the one or more measurement operations using the second frequency of the clock signal.

4. The apparatus of claim 1, wherein the concurrency handling procedure is associated with a processing time interval following the slot, and wherein the processing system is further configured to perform processing associated with the one or more measurement operations during the processing time interval.

5. The apparatus of claim 4, wherein the concurrency handling procedure specifies that a duration of the processing time interval is in accordance with a quantity of frequency resources included in the second set of frequency resources.

6. The apparatus of claim 1, wherein the concurrency handling procedure specifies that no measurements are to be performed concurrently with the wireless communication operation.

7. The apparatus of claim 6, wherein the processing system is further configured to perform one of:
avoid performance of the one or more measurement operations in accordance with the concurrency handling procedure; or
perform, in accordance with the concurrency handling procedure, the one or more measurement operations using a reference signal that is configured to avoid overlap with the wireless communication operation.

8. The apparatus of claim 1, wherein the scheduling information further indicates that a quantity of frequency resources associated with the slot enables the UE to reduce a clock signal of the UE to a first frequency from a second frequency that is greater than the first frequency, and wherein the processing system is further configured to maintain use of the second frequency during the slot.

9. The apparatus of claim 8, wherein the processing system is further configured to transmit, in accordance with detecting that one or more processes of the UE are associated with the second frequency, a message indicating that the UE is to maintain use of the second frequency during the slot.

10. The apparatus of claim 1, wherein the processing system is further configured to detect a concurrency condition associated with the concurrency handling procedure in accordance with:
the one or more measurement operations and the wireless communication operation being concurrently scheduled for the slot; or
the one or more measurement operations and the wireless communication operation being associated with an increase of a frequency of a clock signal of the UE.

11. A method of wireless communication performed by a user equipment (UE), the method comprising:
receiving scheduling information indicating a wireless communication operation scheduled for a slot, the scheduling information further indicating that the wireless communication operation is scheduled to use at least a first set of frequency resources, the slot further associated with one or more measurement operations to be performed by the UE using at least a second set of frequency resources; and
during the slot, performing one or more of the wireless communication operation or the one or more measurement operations in accordance with a concurrency handling procedure.

12. The method of claim 11, wherein the concurrency handling procedure is associated with a priority scheme specifying that one of the wireless communication operation or the one or more measurement operations has a greater priority than the other of the wireless communication operation or the one or more measurement operations, and further comprising dropping, during the slot, the other of the wireless communication operation or the one or more measurement operations.

13. The method of claim 11, wherein the concurrency handling procedure is associated with a switching gap interval, and further comprising:
during the switching gap interval, increasing a frequency of a clock signal of the UE from a first frequency to a second frequency that is greater than the first frequency; and
performing the one or more measurement operations using the second frequency of the clock signal.

14. The method of claim 11, wherein the concurrency handling procedure is associated with a processing time interval following the slot, and further comprising performing processing associated with the one or more measurement operations during the processing time interval.

15. The method of claim 14, wherein the concurrency handling procedure specifies that a duration of the processing time interval is in accordance with a quantity of frequency resources included in the second set of frequency resources.

16. The method of claim 11, wherein the concurrency handling procedure specifies that no measurements are to be performed concurrently with the wireless communication operation.

17. The method of claim 16, further comprising performing one of:
avoiding performance of the one or more measurement operations in accordance with detection of a concurrency condition associated with the concurrency handling procedure; or
performing, in accordance with the concurrency handling procedure, the one or more measurement operations using a reference signal that is configured to avoid overlap with the wireless communication operation.

18. The method of claim 11, wherein the scheduling information further indicates that a quantity of frequency resources associated with the slot enables the UE to reduce a clock signal of the UE to a first frequency from a second frequency that is greater than the first frequency, and further comprising transmitting a message indicating that the UE is to maintain use of the second frequency during the slot.

19. The method of claim 18, wherein the UE transmits the message in accordance with detecting that one or more processes of the UE are associated with the second frequency.

20. An apparatus for wireless communication by a network node, the apparatus comprising:
a processing system comprising one or more processors and one or more memories coupled to the one or more processors, the processing system configured to:
transmit scheduling information indicating a wireless communication operation scheduled for a slot and to be performed by a user equipment (UE), the scheduling information further indicating that the wireless communication operation is scheduled to use at least a first set of frequency resources, the slot further associated with one or more measurement operations to be performed by the UE using at least a second set of frequency resources; and
perform one or more communications with the UE in accordance with the scheduling information and further in accordance with a concurrency handling procedure.
